(19) United States
(12) Patent Application Publication
(10) Pub. No.: US 2021/0146534 A1
(43) Pub. Date: May 20, 2021

(54) Safe Collaborative Gripping Device

(71) Applicant: OnRobot A/S, Odense SØ (DK)

(72) Inventor: Lasse Kieffer, Odense C (DK)

(21) Appl. No.: 17/147,666

(22) Filed: Jan. 13, 2021

Related U.S. Application Data
(63) Continuation of application No. PCT/DK2019/050224, filed on Jul. 8, 2019.

(30) Foreign Application Priority Data
Jul. 16, 2018 (DK) PA 2018 00394

(51) Int. Cl. B25J 9/16; B25J 13/08

(52) U.S. Cl. CPC B25J 9/1633; B25J 9/1612; B25J 9/1674; B25J 13/087; B25J 13/082

(57) ABSTRACT

A method for controlling a gripping device (2) for a robot (20) comprising two or more gripping structures (4, 4′) movably arranged relative to each other and being configured to grip an object (8, 16) is disclosed. The method comprises actively restricting the displacement (ΔD) of at least one of the two or more gripping structures so that said displacement is less than or equal to a predefined maximum displacement (ΔDₘₐₓ). The method comprises the steps of detecting when at least one of the gripping structures is in contact with the object and increasing the force (F) exerted by at least one of the two or more gripping structures to the object from a predefined first level (F₁) to a predefined second level (F₂) when it has been detected that at least one of the two or more gripping structures is in contact with the object.

### CROSS-REFERENCE TO RELATED APPLICATIONS

This application is a continuation under 35 U.S.C. 111 of International Patent Application No. PCT/DK2019/050224, filed Jul. 8, 2019, which claims the benefit of and priority to Danish Application No. PA 2018 00394, filed Jul. 16, 2018, each of which is hereby incorporated by reference in its entirety.

### FIELD OF THE INVENTION

The present invention relates to a method for controlling a gripping device for a robot, e.g. a collaborative robot. The invention more particularly relates to an improved and safe method that can prevent injuries of humans that physically interact with the gripping device. The present invention also relates to a gripping device configured to be attached to a robot, e.g. a collaborative robot.

### BACKGROUND

An increasing number of industries have introduced application of robots due to the pressure to decrease costs, increase production accuracy, and achieve flexible manufacturing. The worldwide demand for cheaper products is one of the reasons that robots more and more frequently are introduced in new working areas. A specialized group of robots, being referred to as collaborative robots, are robots intended to physically interact with humans in a shared workspace. When collaborative robots are applied for gripping and handling objects, a gripping device is typically applied.

A typical gripping device comprises a first gripping structure and a second gripping structure, wherein the first gripping structure and the second gripping structure are arranged to be moved towards and away from each other. These movements introduce a risk for injuries of the humans that physically interact with the robot and the gripping tool. Accordingly, it would be desirable to be able to have a method that eliminates the risk of injuries of humans that physically interact with the robot and the gripping tool.

JPH09225881A discloses a gripping tool (a manipulator) comprising a displacement sensor configured to detect the gripping amount of the gripping tool and control the gripping amount of the gripping tool on the basis of the sensor input. The gripping tool moreover comprises a slip sensor for detecting a slip amount between the gripping tool and an object gripped by the gripping tool. The gripping tool is configured to control the gripping amount on the basis of the slip sensor input. The gripping tool, however, introduces the risk for injuries of humans that physically interact with the gripping tool.

DE3632151A1 discloses a programmable gripper system comprising a gripper and/or a rotary unit, with an integrated position sensor, angle sensor or force sensor. The gripper system is configured to limit the range of motion of the gripper on the basis of measurements made by the sensors. The gripper system, however, introduces the risk for injuries of humans that physically interact with the gripping tool.

### SUMMARY

It is an object of the present invention to provide a method and a gripping device that reduce or even eliminate the risk for injuries of humans that physically interact with the robot and the gripping tool.

It is also an object of the present invention to provide a method and a gripping device that allow humans to physically interact with the gripping tool in a safe manner and at the same time provide a firm and controlled gripping of objects.

A method according to the invention is a method for controlling a gripping device for a robot (e.g. a collaborative robot), wherein said gripping device comprises two or more gripping structures moveably arranged and configured to grip an object, wherein the method comprises the step of restricting the displacement of at least one of the two or more gripping structures so that said displacement is less than or equal to a predefined maximum displacement, wherein the method comprises the steps of a) detecting when at least one of the gripping structures is in contact with the object and b) increasing the force exerted by at least one of the two or more gripping structures to the object from a predefined first level to a predefined second level when it has been detected that at least one of the two or more gripping structures is in contact with the object.

Hereby, it is possible to provide a method that reduces or even eliminates the risk for injuries of the humans that physically interact with the robot and the gripping tool. A method according to the invention is a method for controlling a gripping device in order to minimize the risk for human injuries caused by the gripping device.

A method allows humans to physically interact with the gripping tool in a safe manner and at the same time provides a firm and controlled gripping of objects. The firm gripping is provided by introducing the step of increasing the force exerted by at least one of the two or more gripping structures to the object when at least one of the two or more gripping structures is in contact with the object.

The two or more gripping structures may have any suitable size and geometry. In an embodiment, the method is a method for controlling a gripping device comprising a first gripping structure and a second gripping structure comprising parallel contact surfaces configured to be brought into contact with an object to be handled.

In an embodiment, the gripping device comprises a first gripping structure and a second gripping structure arranged to be moved towards and away from each other. This may be done by using electric, pneumatic or hydraulic actuators. The actuators may be controlled by a control unit.

In an embodiment, the gripping device comprises a single moveably arranged gripping structure and a second passive gripping structure, wherein the moveably arranged gripping structure is configured to be moved relative to the passive gripping structure.

In an embodiment, the gripping device comprises a first gripping structure, a second griping structure and a third gripping structure arranged to be moved towards and away from each other. This may be done by using electric, pneumatic or hydraulic actuators.

A method comprises the step of actively restricting the displacement of at least one of the two or more gripping structures so that said displacement is less than or equal to a predefined maximum displacement. Hereby, by selecting the maximum displacement according to the properties of human tissue, injuries can be prevented, because the gripping structures will not compress a finger or another part of a human to an extent that is critical. The maximum displacement may be selected to be so small that a finger or another part of a human can resist the compression of the gripping structures without sustaining any damage at all.

By the term “actively restricting the displacement” is meant that an active control is carried out so that the displacement is entirely controlled by the activation (or change of activation) of one or more activators applied to move the first gripping structure and/or the second gripping structure. This means that a restriction caused by the rigidity of the mechanical structures provided between the gripping structures, is not within the definition of “restricting the displacement”. By “actively restricting the displacement” the activation of the one or more activators is preferably carried out on the basis of a control signal. The control signal may be provided by using a detection unit and/or one or more sensors configured to detect contact between the object and the first gripping structure and/or the second gripping structure.

A method comprises the step of detecting when at least one of the two or more gripping structures is in contact with the object. The detection of contact can be achieved by using various detection methods.

It is possible to receive information from an external device, wherein the contact detection is provided by using said external device. The detection device may be of any suitable type.

A method comprises the step of increasing the (e.g. compressive) force exerted by at least one of the two or more gripping structures to the object, when at least one of the two or more gripping structures is in contact with the object. Hereby, it is possible to get a firm grip of the object to be gripped/handled by the gripping device. Moreover, it is possible to generate a normal force sufficiently large to achieve a friction force that is large enough to hold the object.

In an embodiment, the predefined maximum displacement is less than 5 mm. In an embodiment, the predefined maximum displacement is less than 2 mm. In an embodiment, the predefined maximum displacement is selected to be equal to or less than 1 mm. In an embodiment, the predefined maximum displacement is selected to be equal to or less than 0.5 mm. In an embodiment, the predefined maximum displacement is selected to be equal to or less than 0.25 mm. In an embodiment, the predefined maximum displacement is selected to be equal to or less than 0.01 mm. In an embodiment, the predefined maximum displacement is selected to be equal to or less than 0.05 mm. Hereby the risk for damaging human tissue is eliminated. Said risk can be eliminated even when the force exerted by at least one of the two or more gripping structures to the object is increased from a predefined first level to a predefined second very high level.

In an embodiment, the ratio between the predefined second level and the predefined first level is at least 2.0.

This can be expressed mathematically in the following way:

$$\frac{{F}_{2}}{{F}_{1}} \geq 2 \qquad ( 1 )$$

In an embodiment, the ratio between the predefined second level and the predefined first level is at least 4. In an embodiment, the ratio between the predefined second level and the predefined first level is at least 8. In an embodiment, the ratio between the predefined second level and the predefined first level is at least 10. In an embodiment, the ratio between the predefined second level and the predefined first level is at least 25. In an embodiment, the ratio between the predefined second level and the predefined first level is at least 50. In an embodiment, the ratio between the predefined second level and the predefined first level is at least 100. In an embodiment, the ratio between the predefined second level and the predefined first level is at least 150. In an embodiment, the ratio between the predefined second level and the predefined first level is at least 200. In an embodiment, the ratio between the predefined second level and the predefined first level is at least 500. In an embodiment, the ratio between the predefined second level and the predefined first level is at least 1000.

In an embodiment, a method comprises the step of increasing the force from the predefined first level to the predefined second level basically linearly as a function of the displacement of at least one of the two or more gripping structures.

In an embodiment, a method comprises the step of increasing the force from the predefined first level to the predefined second level during a force increasing time period less than 500 ms.

In an embodiment, a method comprises the step of increasing the force from the predefined first level to the predefined second level during a force increasing time period less than 400 ms.

In an embodiment, a method comprises the step of increasing the force from the predefined first level to the predefined second level during a force increasing time period less than 300 ms.

In an embodiment, a method comprises the step of increasing the force from the predefined first level to the predefined second level during a force increasing time period less than 200 ms.

In an embodiment, a method comprises the step of increasing the force from the predefined first level to the predefined second level during a force increasing time period less than 100 ms.

In an embodiment, a method comprises the step of increasing the force from the predefined first level to the predefined second level during a force increasing time period less than 75 ms.

In an embodiment, a method comprises the step of increasing the force from the predefined first level to the predefined second level during a force increasing time period less than 50 ms.

In an embodiment, a method comprises the step of increasing the force from the predefined first level to the predefined second level during a force increasing time period less than 25 ms.

In an embodiment, a method comprises the step of increasing the force from the predefined first level to the predefined second level during a force increasing time period less than 10 ms.

In an embodiment, a method comprises the step of increasing the force from the predefined first level to the predefined second level during a force increasing time period less than 5 ms.

In an embodiment, a method comprises the step of increasing the force from the predefined first level to the predefined second level during a force increasing time period less than 2 ms.

In an embodiment, a method comprises the step of increasing the force from the predefined first level to the predefined second level during a force increasing time period less than 1 ms.

In an embodiment, a method comprises the step of increasing the force from the predefined first level to the predefined second level during a force increasing time period less than 0.5 ms.

In an embodiment, a method comprises the step of increasing the force from the predefined first level to the predefined second level during a force increasing time period less than 0.1 ms.

By increasing the force from the predefined first level to the predefined second level during a short force increasing time period it is possible to ensure that an object is gripped and maintained in the griped position. If the force increasing time period is too long, it would introduce a risk of the object slipping out of the gripping device.

In an embodiment, a method comprises the steps of: a) detecting when at least one of the gripping structures has been in contact with the object in a predefined time period and b) only increasing the force exerted by at least one of the two or more gripping structures to the object if at least one of gripping structures has been in contact with the object in a time period longer than or equal to the predefined time period.

Hereby, the risk for incorrectly detecting contact between the object and at least one of the gripping structures can be eliminated. If, one or more of the gripping structures has been in contact with the object for a very short time period, the contact detection may be erroneous and thus create a fallacy. Accordingly, requiring that at least one of the gripping structures must have been in contact with the object for a time period longer than or equal to the predefined time period eliminates the risk for detecting a contact by mistake.

In an embodiment, the predefined time period is 1 ms.

In an embodiment, the predefined time period is 2 ms.

In an embodiment, the predefined time period is 4 ms.

In an embodiment, the predefined time period is 10 ms.

In an embodiment, the predefined time period is 20 ms.

In an embodiment, the predefined time period is 50 ms.

In an embodiment, the predefined time period is 100 ms.

In an embodiment, the predefined time period is 150 ms.

In an embodiment, the predefined time period is 200 ms.

In an embodiment, the predefined time period is 300 ms.

In an embodiment, the predefined time period is 500 ms.

In an embodiment, the predefined time period is 750 ms.

In an embodiment, the predefined time period is 1000 ms.

In an embodiment, the predefined time period is 2 s.

In an embodiment, the predefined time period is 5 s.

In an embodiment, the predefined time period is 10 s.

In an embodiment, the detection of when at least one of the gripping structures is in contact with the object is carried out by measuring a pressure with which at least one of the two or more gripping structures presses against the object, wherein said pressure is measured by means of a detection unit comprising one or more sensor members, wherein contact between the object and at least one of the gripping structures is defined as when a pressure exceeding a predefined pressure level is detected.

In an embodiment, contact is defined to occur when the average pressure detected by the pressure sensing sensor members exceeds a predefined upper pressure level.

In an embodiment, contact is defined to occur when the average pressure detected by a predefined number of pressure sensing sensor members exceeds the predefined upper pressure level. In an embodiment, the number of pressure sensing sensor members may be 1-5. In an embodiment, the number of pressure sensing sensor members may be 5-10. In an embodiment, the number of pressure sensing sensor members may be 10-20. In an embodiment, the number of pressure sensing sensor members may be 20-50. In an embodiment, the number of pressure sensing sensor members may be more than 50.

Hereby, the sensor members can be used to detect contact in a reliable manner.

In an embodiment, the method comprises the step of: a) initially letting the two or more gripping structures move without restricting their relative displacement with respect to each other as long as none of the gripping structures are in contact with the object.

Hereby, the two or more gripping structures can move “freely” (without displacement restrictions) relative to each other as long as none of the gripping structures is provided in a distance from the object. Furthermore, when contact is detected the displacement is restricted so that tissue damage can be avoided.

It may be beneficial that a method comprises the step of controlling the magnitude of the pressure with which at least one of the two or more gripping structures presses against the object. Hereby, it is possible to avoid a too high or too low pressure being provided between at least one of the two or more gripping structures and the object. Accordingly, it can be ensured that a sufficiently large friction force is provided during lifting tasks.

It may be advantageous that a method comprises the step of detecting at least one parameter indicative of the pressure or force with which at least one of the two or more gripping structures presses against the object. Hereby, it is possible to determine if the pressure should be increased (in order to achieve a sufficiently high friction force) or if the pressure should be reduced.

It may be an advantage that a method comprises the step of measuring a current and/or a voltage and/or a force of an actuator arranged to drive at least one of the two or more gripping structures, wherein the contact with an object is defined on the basis of the measured current and/or a voltage and/or force. Hereby, it is possible to apply simple electric measurements to detect contact. Accordingly, a simple, cheap and reliable method can be provided.

It may be advantageous that a method comprises the step of applying one or more sensors to detect the contact with the object. Hereby, it is possible to provide reliable information to be used to detect contact.

A gripping device according to the invention is a gripping device for a robot, said gripping device comprising:
two or more gripping structures moveably arranged relative to each other and being configured to grip an object;
a detection unit configured to detect when an object is in contact with at least one of the two or more gripping structures;
one or more actuators configured to make at least one of the two or more gripping structures move to grip the object; and
a control unit configured to control the one or more actuators,
   wherein the control unit is configured to restrict the displacement of at least one of the two or more gripping structures so that said displacement is less than or equal to a predefined maximum displacement, wherein the gripping device is configured to increase the force exerted by at least one of the two or more gripping structures to the object from a predefined first level to a predefined second higher level when the detection unit has detected that at least one of the two or more gripping structures is in contact with the object.

Hereby, it is possible to provide a method that reduces or even eliminates the risk for injuries of the humans that physically interact with the robot and the gripping tool. The gripping device allows humans to physically interact with the gripping tool in a safe manner and at the same time provides a firm and controlled gripping of objects. By increasing the force exerted by at least one of the two or more gripping structures to the object when at least one of the two or more gripping structures is in contact with the object, it is possible to provide a firm griping by using the gripping device.

In an embodiment, the control unit is configured to restrict the displacement of all gripping structures so that said displacement is less than or equal to a predefined maximum displacement.

The first gripping structures may have any suitable size and geometry. The gripping device may be configured to be used together with a collaborative robot.

In an embodiment, the predefined maximum displacement is within the range 0.1-1.0 mm such as 0.2-0.5 mm. In an embodiment, the predefined maximum displacement is equal to or less than 5 mm. In an embodiment, the predefined maximum displacement is equal to or less than 2 mm. In an embodiment, the predefined maximum displacement is equal to or less than 1 mm. In an embodiment, the predefined maximum displacement is equal to or less than 0.5 mm. In an embodiment, the predefined maximum displacement is equal to or less than 0.2 mm. In an embodiment, the predefined maximum displacement is equal to or less than 0.1 mm. In an embodiment, the predefined maximum displacement is equal to or less than 0.05 mm. By restricting the maximum displacement, the risk for damaging human tissue can be eliminated.

In an embodiment, the ratio between the predefined second higher level and the predefined first level is at least 2.0. In an embodiment, the ratio between the predefined second level and the predefined first level is at least 4. In an embodiment, the ratio between the predefined second level and the predefined first level is at least 8. In an embodiment, the ratio between the predefined second level and the predefined first level is at least 10. In an embodiment, the ratio between the predefined second level and the predefined first level is at least 25. In an embodiment, the ratio between the predefined second level and the predefined first level is at least 50. In an embodiment, the ratio between the predefined second level and the predefined first level is at least 100. In an embodiment, the ratio between the predefined second level and the predefined first level is at least 150. In an embodiment, the ratio between the predefined second level and the predefined first level is at least 200. In an embodiment, the ratio between the predefined second level and the predefined first level is at least 500. In an embodiment, the ratio between the predefined second level and the predefined first level is at least 1000.

In an embodiment, the gripping device is configured to increase the force from the predefined first level to the predefined second level basically linearly as a function of the displacement of at least one of the two or more gripping structures.

In an embodiment, the gripping device is configured to increase the force from the predefined first level to the predefined second level during a force increasing time period less than 500 ms.

In an embodiment, the gripping device is configured to increase the force from the predefined first level to the predefined second level during a force increasing time period less than 400 ms.

In an embodiment, the gripping device is configured to increase the force from the predefined first level to the predefined second level during a force increasing time period less than 300 ms.

In an embodiment, the gripping device is configured to increase the force from the predefined first level to the predefined second level during a force increasing time period less than 200 ms.

In an embodiment, the gripping device is configured to increase the force from the predefined first level to the predefined second level during a force increasing time period less than 100 ms.

In an embodiment, the gripping device is configured to increase the force from the predefined first level to the predefined second level during a force increasing time period being less than 75 ms.

In an embodiment, the gripping device is configured to increase the force from the predefined first level to the predefined second level during a force increasing time period less than 50 ms.

In an embodiment, the gripping device is configured to increase the force from the predefined first level to the predefined second level during a force increasing time period less than 25 ms.

In an embodiment, the gripping device is configured to increase the force from the predefined first level to the predefined second level during a force increasing time period less than 10 ms.

In an embodiment, the gripping device is configured to increase the force from the predefined first level to the predefined second level during a force increasing time period less than 5 ms.

In an embodiment, the gripping device is configured to increase the force from the predefined first level to the predefined second level during a force increasing time period less than 2 ms.

In an embodiment, the gripping device is configured to increase the force from the predefined first level to the predefined second level during a force increasing time period less than 1 ms.

In an embodiment, the gripping device is configured to increase the force from the predefined first level to the predefined second level during a force increasing time period less than 0.5 ms.

In an embodiment, the gripping device is configured to increase the force from the predefined first level to the predefined second level during a force increasing time period less than 0.1 ms.

By increasing the force from the predefined first level to the predefined second level during a short force increasing time period it is possible to ensure that an object is gripped and maintained in the griped position. If the force increasing time period is too long, it would introduce a risk of the object slipping out of the gripping device.

In an embodiment, the detection unit is configured to detect when at least one of the gripping structures has been in contact with the object for a predefined time period, wherein the control unit is configured to only increase the force exerted by at least one of the two or more gripping structures to the object if at least one of the gripping structures has been in contact with the object for a time period longer than or equal to the predefined time period.

Hereby, the risk for incorrectly detecting contact between the object and at least one of the gripping structures can be eliminated. If, one or more of the gripping structures has been in contact with the object for a very short time period, the contact detection may be erroneous and thus create a fallacy. Accordingly, requiring that at least one of gripping structures must have been in contact with the object for a time period longer than or equal to the predefined time period eliminates the risk of detecting a contact by mistake.

In an embodiment, the predefined time period is 1 ms.

In an embodiment, the predefined time period is 2 ms.

In an embodiment, the predefined time period is 4 ms.

In an embodiment, the predefined time period is 10 ms.

In an embodiment, the predefined time period is 20 ms.

In an embodiment, the predefined time period is 50 ms.

In an embodiment, the predefined time period is 100 ms.

In an embodiment, the predefined time period is 150 ms.

In an embodiment, the predefined time period is 200 ms.

In an embodiment, the predefined time period is 300 ms.

In an embodiment, the predefined time period is 500 ms.

In an embodiment, the predefined time period is 750 ms.

In an embodiment, the predefined time period is 1000 ms.

In an embodiment, the predefined time period is 2 s.

In an embodiment, the predefined time period is 5 s.

In an embodiment, the predefined time period is 10 s.

In an embodiment, the detection of when at least one of the gripping structures is in contact with the object is carried out by measuring a pressure with which at least one of the two or more gripping structures presses against the object, wherein said pressure is measured by means of a detection unit comprising one or more sensor members, wherein contact between the object and at least one of the gripping structures is defined as when a pressure exceeding a predefined pressure level is detected.

In an embodiment, contact is defined to occur when the average pressure detected by the pressure sensing sensor members exceeds a predefined upper pressure level.

In an embodiment, contact is defined to occur when the average pressure detected by a predefined number of pressure sensing sensor members exceeds the predefined upper pressure level. In an embodiment, the number of pressure sensing sensor members may be 1-5. In an embodiment, the number of pressure sensing sensor members may be 5-10. In an embodiment, the number of pressure sensing sensor members may be 10-20. In an embodiment, the number of pressure sensing sensor members may be 20-50. In an embodiment, the number of pressure sensing sensor members may be more than 50. Hereby, the sensor members can be used to detect contact in a reliable manner.

In an embodiment, the gripping device is configured to initially let the two or more gripping structures move without restricting their relative displacement with respect to each other as long as none of the gripping structures is in contact with the object.

Hereby, the two or more gripping structures can move “freely” (without displacement restrictions) relative to each other as long as none of the gripping structures is provided in a distance from the object. Furthermore, when contact is detected the displacement is restricted so that tissue damage can be avoided.

In an embodiment, the gripping device is configured to control the magnitude of the pressure with which at least one of the two or more gripping structures presses against the object. Hereby, it is possible to avoid a too high or too low pressure being provided between at least one of the two or more gripping structures and the object. Accordingly, it can be ensured that a sufficiently large friction force is provided during lifting tasks.

It may be advantageous that the gripping device is configured to detect at least one parameter indicative of the pressure or force with which at least one of the two or more gripping structures presses against the object. Hereby, it is possible to determine if the pressure should be increased (in order to achieve a sufficiently high friction force) or if the pressure should be reduced.

It may be an advantage that the gripping device is configured to measure a current and/or a voltage and/or a force of an actuator arranged to drive at least one of the two or more gripping structures, wherein the contact with an object is defined on the basis of the measured current and/or a voltage and/or force. Hereby, it is possible to apply simple electric measurements to detect contact. Accordingly, a simple, cheap and reliable device can be provided.

It may be advantageous that the gripping device comprises one or more sensors to detect the contact with the object. Hereby, it is possible to provide reliable information to be used to detect contact.

In an embodiment, the gripping device comprises an integrated detection unit configured to detect when the object is in contact with at least one of the two or more gripping structures on the basis of measurements performed on one or more of the actuators, wherein the control unit is configured to restrict the displacement of at least one of the two or more gripping structures when the integrated detection unit has detected that the object is in contact with at least one of the two or more gripping structures.

In an embodiment, the gripping device comprises a first gripping structure and a second gripping structure arranged to be moved towards and away from each other. In an embodiment, both the first gripping structure and the second gripping structure are moveably arranged. In another embodiment, either the first gripping structure or the second gripping structure is moveably arranged, wherein the other one is fixed.

The detection unit is configured to detect when an object is in contact with at least one of the one or more gripping structures. The detection unit may be of any suitable type and size.

In an embodiment, the one or more actuators are electrically driven.

In another embodiment, the one or more actuators are pneumatically driven.

In a further embodiment, the one or more actuators are hydraulically driven.

The actuators are configured to make at least one of the one or more gripping structures move (e.g. towards each other).

In an embodiment, the actuators are configured to make at least one of the one or more gripping structures move (e.g. towards each other, e.g. by moving both a first gripping structure and/or a second gripping structure).

In another embodiment, a single actuator is used to move either a first gripping structure or a second gripping structure towards the other by moving only one of the gripping structures, wherein the other gripping structure is fixed.

The control unit is configured to control the one or more actuators in a manner in which the displacement of at least one of the one or more gripping structures is restricted in such a manner that the displacement is less than or equal to a predefined maximum displacement.

By restricting the displacement of at least one of the one or more gripping structures so that said displacement is less than or equal to a predefined maximum displacement, injuries can be prevented.

By the term “actively restricting the displacement” is meant that an active control is carried out so that the displacement is entirely controlled by the activation of one or more activators applied to move the first gripping structure and/or the second gripping structure. This means that a restriction caused by the rigidity of the mechanical structures provided between the gripping structures, is not within the definition of “restricting the displacement”. By “actively restricting the displacement” the activation of the one or more activators is preferably carried out on the basis of a control signal. The control signal may be provided by using a detection unit and/or one or more sensors configured to detect contact between the object and the first gripping structure and/or the second gripping structure.

In an embodiment, the maximum displacement is selected according to predefined properties of human tissue (e.g. the skin and the subcutaneous tissue). The maximum displacement is preferably selected to be so small that a finger or another part of a human can resist the compression of the gripping structures without sustaining any damage at all. Injuries can be prevented because the gripping structures will not compress a finger or another part of a human to an extent that is critical for human tissue.

It may be advantageous that the gripping device comprises a detection unit configured to detect when an object is in contact with at least one of the one or more gripping structures on the basis of measurements performed on one or more of the actuators and that the control unit is configured to restrict the displacement of at least one of the one or more structures when the (integrated) detection unit has detected that the object is in contact with at least one of the one or more gripping structures. The detection unit may be an integrated detection unit.

Hereby, it is possible to provide a simple, cheap and reliable gripping device.

It may be an advantage that the detection unit comprises one or more sensor members. Hereby, the sensor members can be used to detect contact in a reliable manner.

In an embodiment, the one or more sensor members are pressure sensitive sensor members.

It may be beneficial that the control unit is configurable so that the predefined maximum displacement and/or the predefined level can be set.

The setting may be carried out by using an external device (e.g. a tablet, a smartphone or a computer) that is configured to communicate with the control unit.

In an embodiment, the gripping device is configurable using a human machine interface (e.g. a touch screen) that is an integrated part of the gripping device.

In an embodiment, the control unit is configured to initially let the two or more gripping structures move without restricting their relative displacement (with respect to each other) as long as none of the gripping structures are in contact with the object.

In an embodiment, the control unit is configured to detect when at least one of gripping structures is in contact with the object and restrict the displacement of at least one of the two or more gripping structures when it has been detected that at least one of gripping structures is in contact with the object.

In an embodiment, the control unit is configured to increase the force exerted by at least one of the gripping structures to the object when it has been detected that the at least one of the two or more gripping structures is in contact with the object.

Hereby, it is possible to increase the normal force and thus the friction force and thus provide a firm grip of the object.

### BRIEF DESCRIPTION OF THE DRAWINGS

The invention will become more fully understood from the detailed description given herein below. The accompanying drawings are given by way of illustration only, and thus, they are not limitative of the present invention. In the accompanying drawings:

FIG. 1A shows a side perspective view of a gripping device according to the invention in a first configuration;

FIG. 1B shows a perspective view of the gripping device shown in FIG. 1A in a second configuration;

FIG. 1C shows a close-up view of the gripping device shown in FIG. 1A and FIG. 1B in a third configuration;

FIG. 2 shows a close-up view of a gripping device according to the invention;

FIG. 3A shows a graph depicting the force exerted by the gripping device as a function of the displacement of the gripping structures relative to each other in an embodiment of the invention;

FIG. 3B shows a graph depicting the force exerted by the gripping device as a function of the displacement of the gripping structures relative to each other in another embodiment of the invention;

FIG. 4A shows a side view of a gripping structure of a gripping device according to the invention;

FIG. 4B shows a front-view of a pressure sensor;

FIG. 4C shows a graph depicting the pressure distribution along a line (row) of pressure sensing elements of the pressure sensor shown in FIG. 4B;

FIG. 5 shows a cross-sectional view of a gripping device according to the invention;

FIG. 6 shows a gripping device according to the invention being attached to a collaborative robot;

FIG. 7A shows a top view of a gripping device according to the invention, wherein the gripping device is operated in a mode in which the gripping structures are not in contact with the object to be handled, in which mode the gripping structures are moved without restricting their relative displacement with respect to each other;

FIG. 7B shows a top view of the gripping device shown in FIG. 7A, in a configuration in which there is contact between the object and the gripping structures;

FIG. 8A shows a top view of a gripping device according to the invention comprising two gripping structures each connected to a connection member that is rotatably attached to an actuator;

FIG. 8B shows a gripping device according to the invention configured to grip a tubular structure in a first configuration; and

FIG. 8C shows the gripping device shown in FIG. 8B in another configuration.

### DETAILED DESCRIPTION

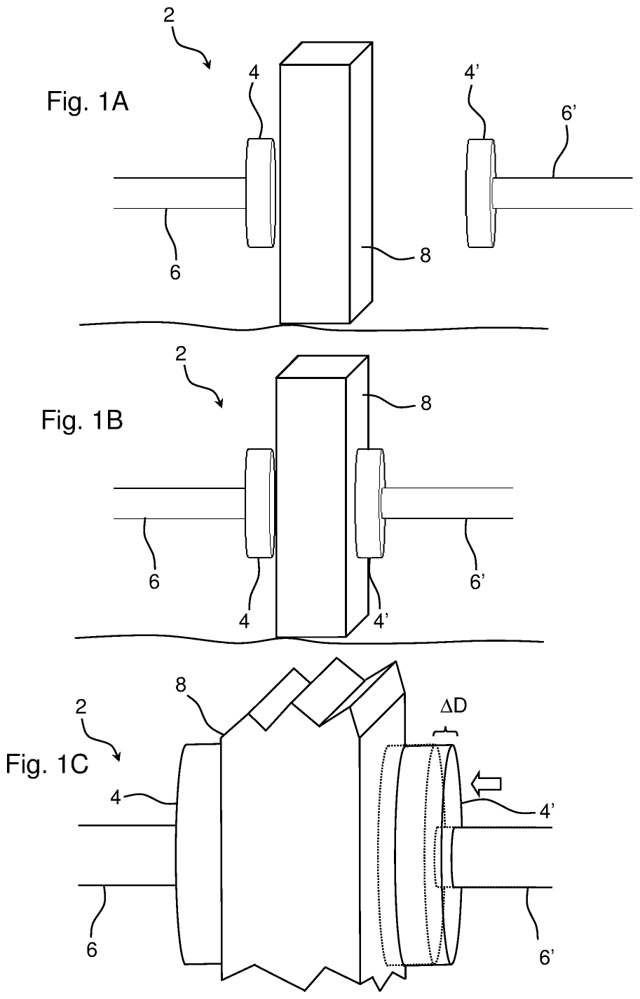

Referring now in detail to the drawings for the purpose of illustrating preferred embodiments of the present invention, a portion of a gripping device 2 of the present invention is illustrated in FIG. 1A. FIG. 1A illustrates a perspective view of a gripping device 2 according to the invention in a first configuration, in which a first gripping structure 4 and a second gripping structure 4′ of the gripping device 2 are moved toward each other in order to grip an object 8 arranged there between. The first gripping structure 4 is provided in the distal end of a first rod-shaped connection member 6. Likewise, the second gripping structure 4′ is provided in the distal end of a second rod-shaped connection member 6′.

The gripping device 2 comprises one or more actuators (not shown) configured to move the gripping structures 4, 4′ towards each other and away from each other by moving at least one of the connection members 6, 6′.

FIG. 1B illustrates a perspective view of a portion of the gripping device 2 shown in FIG. 1A in a second configuration, in which the gripping structures 4, 4′ have been moved further towards each other.

FIG. 1C illustrates a close-up view of the gripping device 2 shown in FIG. 1A and FIG. 1B in a third configuration, in which the first gripping structure 4 has been brought into contact with the object 8.

The contact triggers the control unit (not shown) of the gripping device 2 to restrict the displacement ΔD of the first gripping structure 4 relative to the second gripping structure 4′. Accordingly, the gripping device 2 is operated in a manner in which the displacement ΔD is less than or equal to a predefined maximum displacement, ΔDₘₐₓ. In an embodiment, the predefined maximum displacement, ΔDₘₐₓ is within the range 0.1-1.0 mm such as 0.2-0.5 mm.

The initial position (before the displacement of the first gripping structure 4 relative to the second gripping structure 4′) is indicated with a solid line, whereas the end position (when the first gripping structure 4 has been moved towards the second gripping structure 4′) is indicated with a dotted line.

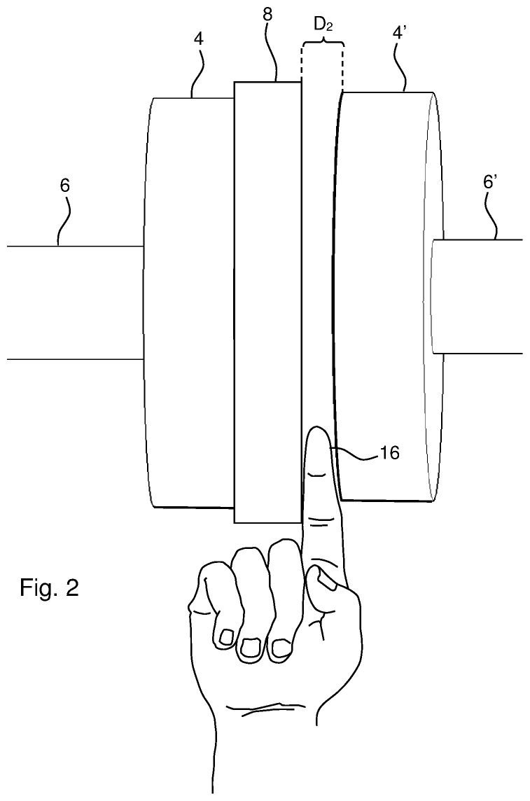

FIG. 2 illustrates a close-up view of a portion of a gripping device 2 according to the invention. The gripping device 2 comprises two parallel connection members 6, 6′ that each carry a disc-shaped gripping structure 4, 4′ provided at the distal end. An object 8 is arranged between the first gripping structure 4 and the second gripping structure 4′.

A finger 16 of a human is arranged between the object 8 and the second gripping structure 4′. When the gripping device 2 detects that there is contact with the finger 16 and the second gripping structure 4′, this detected contact triggers the control unit (not shown) of the gripping device 2 to restrict the displacement of the first gripping structure 4 relative to the second gripping structure 4′.

Accordingly, the gripping device 2 is operated in a manner in which the distance D₂ between the object and the second gripping structure 4′ is restricted. Accordingly, the gripping device 2 is configured to prevent the finger from being injured by the compressive force exerted to the finger by the gripping structures 4, 4′ or the object 8 and one of the gripping structures 4, 4′.

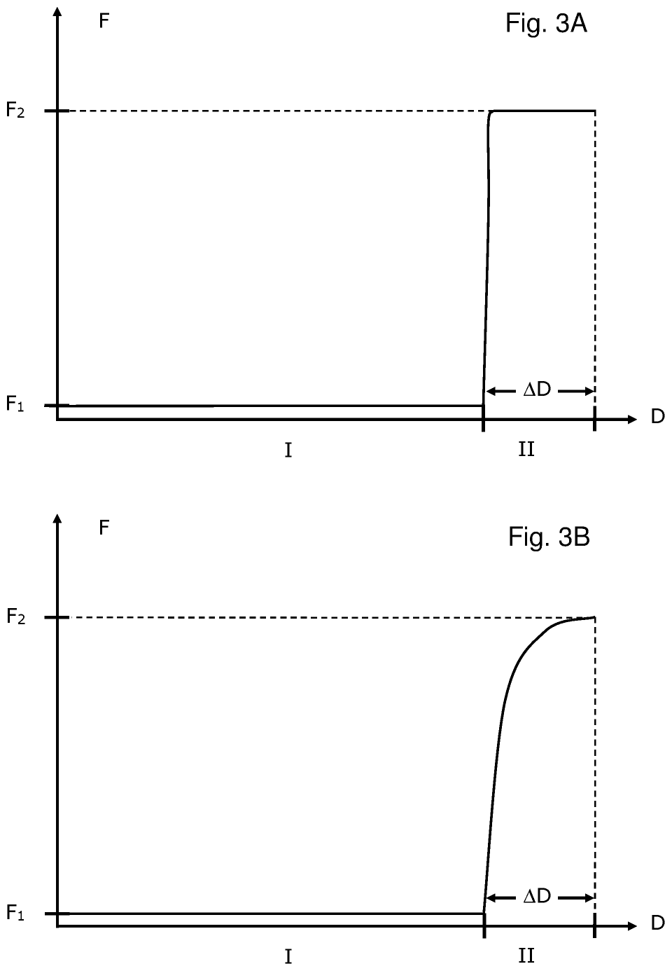

FIG. 3A illustrates a graph depicting the force F exerted by the gripping device as a function of the displacement D of the gripping structures relative to each other in an embodiment of the invention. In the initial phase I, the gripping structures are moved towards each other and the force F₁ exerted by the gripping structures is very low (close to zero). When contact with an object is reached (in phase II) by either the first gripping structure or the second gripping structure, the force F₂ exerted by the gripping structures (towards the object) is increased almost instantaneously to a high level (indicated with a dotted line). This high-level force F₂ is sufficiently large to achieve a reaction force (normal force) required to provide a friction force of sufficient magnitude to maintain a firm grip of the object.

It can be seen that the displacement ΔD in the second phase II is limited. Thus, the gripping structures are restricted from injuring a finger or another part of a human that is brought into contact with one of the gripping structures.

FIG. 3B illustrates a graph depicting the force F exerted by the gripping device as a function of the displacement D of the gripping structures relative to each other in another embodiment of the invention. In the initial phase I the gripping structures are moved towards each other and the force F₁ exerted by the gripping device is very low. However, when contact with an object is reached (in phase II) by either the first gripping structure or the second gripping structure, the force F₂ exerted by the gripping device (towards the object) is ramped up to a high level (indicated with a dotted line).

As the displacement ΔD in the second phase II is limited (restricted), the gripping device is restricted from injuring a finger or another part of a human that is brought into contact with one of the gripping structures of the gripping device.

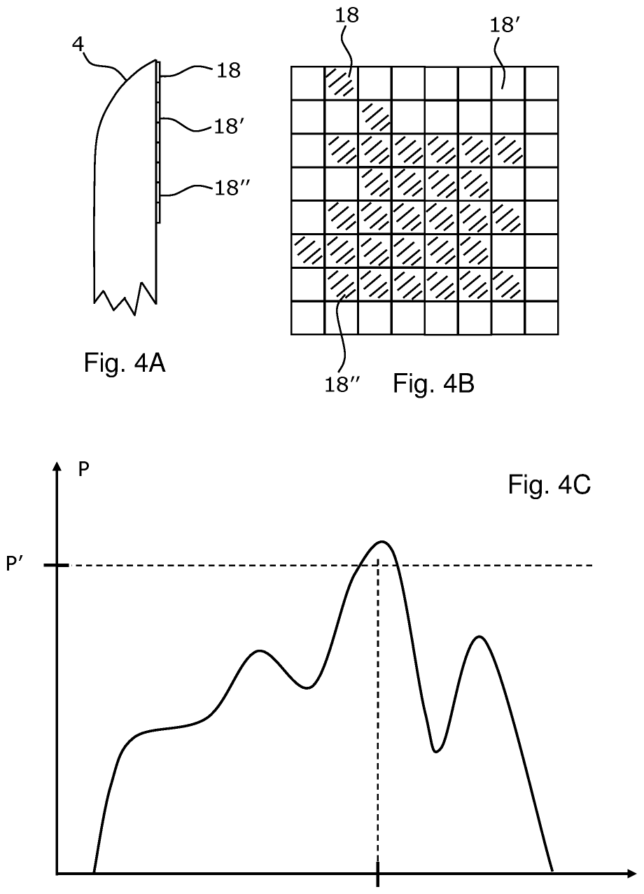

FIG. 4A illustrates a side view of a gripping structure 4 of a gripping device according to the invention. The gripping structure 4 comprises a gripping surface provided with a sensor comprising a plurality of sensor members 18, 18′, 18″ each configured to measure pressure.

FIG. 4B illustrates a front-view of a pressure sensor of the type that basically corresponds to the one shown in FIG. 4A. The pressure sensor, however, comprises more sensor members 18, 18′, 18″ each configured to measure pressure.

FIG. 4C illustrates a graph depicting the pressure P distribution along a line (row) of pressure sensing elements of the pressure sensor shown in FIG. 4B. It can be seen that in the central part of the graph, the pressure P exceeds a predefined upper pressure level P′. Accordingly, some of the pressure sensing sensor members detect a pressure that exceeds the predefined upper pressure level P′.

In an embodiment, contact is defined to occur when one or more of the pressure sensing sensor members detect a pressure that exceeds the predefined upper pressure level P′.

In another embodiment, contact is defined to occur when the average pressure detected by the pressure sensing sensor members exceeds the predefined upper pressure level P′.

In a further embodiment, contact is defined to occur when the average pressure detected by a predefined number (e.g. 10 or 20) of pressure sensing sensor members exceeds the predefined upper pressure level P′.

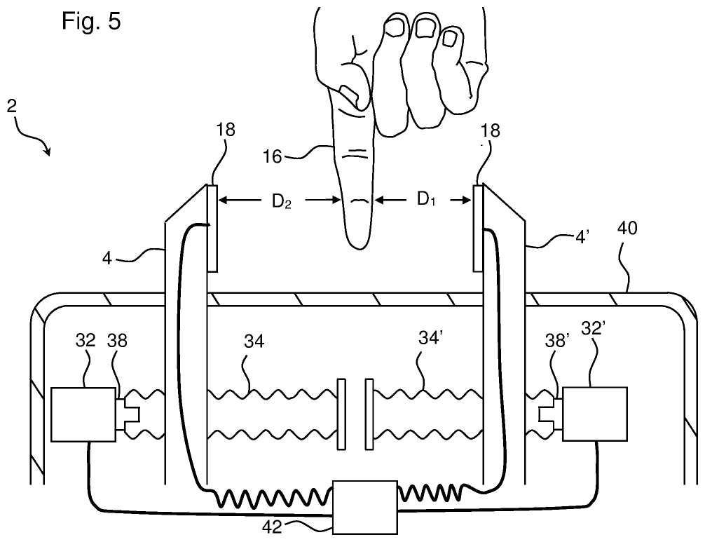

FIG. 5 illustrates a cross-sectional view of a gripping device 2 according to the invention. The gripping device 2 comprises a first gripping structure 4 that is rotatably attached to a first threaded rod 34. The gripping device 2 comprises a second gripping structure 4′ rotatably attached to a second threaded rod 34′.

A first actuator formed as an electric motor 32 is coupled to the first threaded rod 34 by means of a first rod-shaped connection structure 38. A second actuator formed as an electric motor 32′ is coupled to the second threaded rod 34′ by means of a second rod-shaped connection structure 38′. Each of the electric motors 32, 32′ are electrically connected to a control unit 42 by means of cables. In an alternative embodiment, the electric motors 32, 32′ may be wirelessly connected to the control unit 42 and electrically connected to a power supply (e.g. a battery).

The control unit 42 is electrically connected to sensor members 18 provided at a surface of the gripping structures 4, 4′. In an alternative embodiment, the sensor members 18 may be wirelessly connected to the control unit 42.

The gripping device 2 comprises a housing 40. The gripping structures 4, 4′ protrude from the housing 40 of the gripping device 2. A human finger 16 is arranged in the space between the gripping structures 4, 4′ in non-zero distances D₁, D₂ from each of the gripping structures 4, 4′, respectively. When the gripping structures 4, 4′ gradually are moved toward each other, the distances D₁, D₂ between the finger 16 and the griping structures 4, 4′ will gradually decrease until there is contact between the finger 16 and one of the gripping structures 4, 4′.

When the gripping device 2 detects that there is contact with the finger 16 and the second gripping structure 4′, this contact triggers the control unit 42 of the gripping device 2 to restrict the displacement of the first gripping structure 4 relative to the second gripping structure 4′. In practice, the control unit 42 may control the electric motors 32, 32′ in a first mode when no contact has been detected and in another mode when contact has been detected.

In an embodiment, the contact between the finger 16 and one of the gripping structures 4, 4′ is detected by using one or more sensor members 18.

In another embodiment, the contact between the finger 16 and one of the gripping structures 4, 4′ is detected on the basis of measurement(s) of the current and/or voltage and/or power of at least one of the electric motors 32, 32′.

The gripping device 2 is operated in a manner, in which the distance D₁, D₂ between the finger 16 and the gripping structures 4, 4′ is restricted, when contact is detected. Accordingly, the gripping device 2 is configured to prevent the finger 16 from being injured by the compressive force exerted to the finger by the gripping structures 4, 4′ or an object (not shown) and one of the gripping structures 4, 4′.

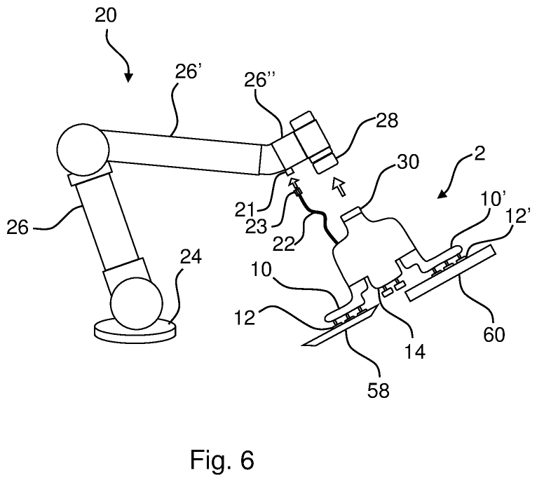

FIG. 6 illustrates a gripping device 2 according to the invention being attached to a collaborative robot 20. The robot 20 comprises a base 24 and a first arm 26 rotatably attached to said base 24. The robot 20 further comprises a second arm 26′ rotatably attached to the first arm 26. The robot 20 moreover comprises a third arm 26″ rotatably attached to the second arm 26′.

A first portion 28 is provided at the end of the third arm 26″. The first portion 28 is configured to receive a corresponding second portion 30 attached to the gripping device 2.

The robot 20 comprises a socket 21 configured to receive a corresponding plug 23 of the gripping device 2 in order to electrically connect the gripping device 2 and the robot 20. The plug 23 is attached at the distal end of a cable 22 connected to the gripping device 2.

The gripping device 2 comprises a body portion and a plurality of extremities 10, 10′ moveably attached to the body portion of the gripping device 2. The first extremity 10 is provided with a plurality of suction members 12 gripping a first object 58 by providing a negative pressure in the suction members 12.

The second extremity 10′ is provided with a plurality of suction members 12′ gripping a second object 60 by providing a negative pressure in the suction members 12′. The gripping device 2 comprises a centrally arranged support portion 14 provided with several suction members.

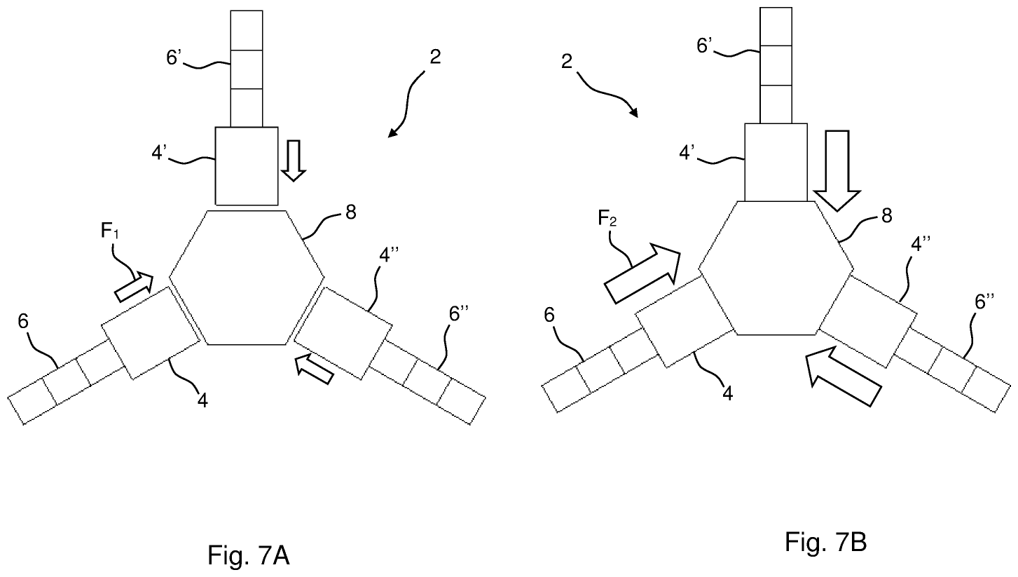

FIG. 7A illustrates a top view of a gripping device 2 according to the invention, wherein the gripping device 2 is operated in a non-contact mode (a mode in which the gripping structures 4, 4′, 4″ are not in contact with the object 8 to be handled). The gripping structures 4, 4′, 4″ are moved (by means of actuators which are not shown) towards the object 8 without restricting their relative displacement with respect to each other. The first gripping structure 4 is arranged at the distal end of a first connection member 6, the second gripping structure 4′ is arranged at the distal end of a second connection member 6′ and the third gripping structure 4″ is arranged at the distal end of a third connection member 6″.

The magnitude of the force F₁ applied to the gripping members 4, 4′, 4″ for moving them towards the object 8 is indicated by arrows.

FIG. 7B illustrates a top view of the gripping device 2 shown in FIG. 7A, in a contact mode (a configuration in which contact has been detected between the object 8 and the gripping structures 4, 4′, 4″). Since contact has been detected between the object 8 and the gripping structures 4, 4′, 4″, the control unit (not shown) is operated in a mode in which the one or more actuators (not shown) arranged to move the gripping structures 4, 4′, 4″ will restrict the displacement of at least one of the gripping structures 4, 4′, 4″ towards the object 8 so that the displacement is less than or equal to a predefined maximum displacement. Hereby, it is possible to avoid damage of a human tissue (e.g. a finger of a human) arranged between the gripping structures 4, 4′, 4″. It can be seen that the magnitude of the force F₂ applied to the gripping members 4, 4′, 4″ for pressing them towards the object 8 is indicated by arrows. When comparing FIG. 7A and FIG. 7B it can be seen that F₂ is larger than F₁. Thus, in the contact mode, the force F₂ exerted by at least one of the gripping structures 4, 4′, 4″ to the object 8 is increased compared to the non-contact mode (shown in FIG. 7A).

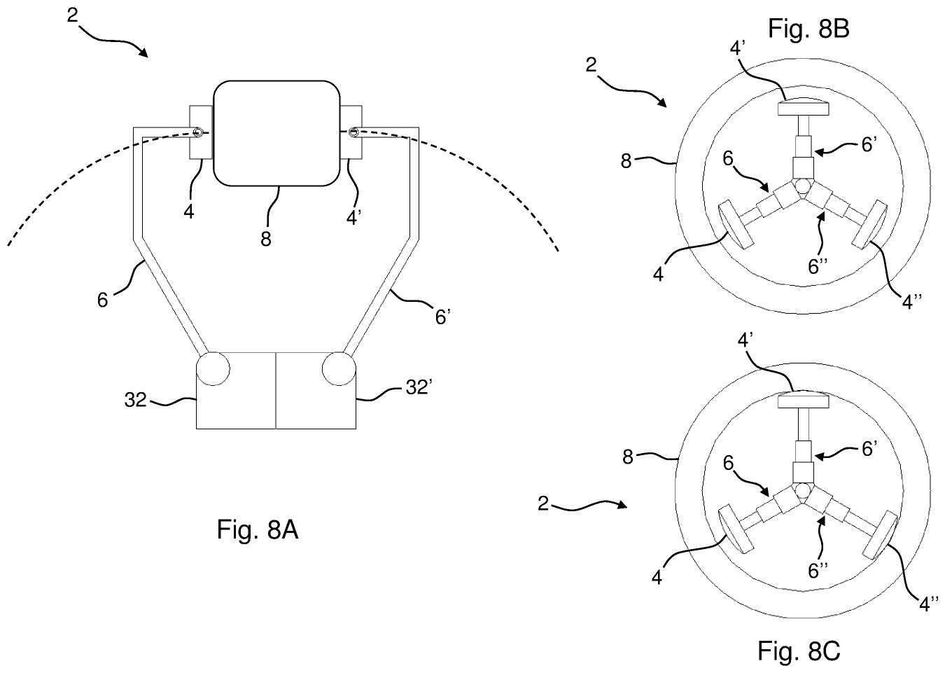

FIG. 8A illustrates a top view of a gripping device 2 according to the invention comprising two gripping structures 4, 4′ each connected to a connection member 6, 6′ that is rotatably attached to an actuator 32, 32′. The first gripping structure 4 is attached to a first connection member 6 being rotatably attached to a first actuator 32. The second gripping structure 4′ is attached to a second connection member 6′ that is rotatably attached to a second actuator 32′. Accordingly, the first actuator 32 and the second actuator 32′ can be operated independently of each other. The arced movement pattern of the first gripping structure 4 and the second gripping structure 4′ is indicated with dashed lines.

The gripping structures 4, 4′ are brought into contact with an object 8. The gripping device 2 comprises a detection unit (not shown) configured to detect when the object 8 is in contact with at least one of the gripping structures 4, 4′.

The gripping device 2 comprises a control unit (not shown) configured to control the actuators 32, 32′ and to restrict the displacement of at least one of the gripping structures 4, 4′ towards the object 8 so that the displacement is less than or equal to a predefined maximum displacement. Hereby, damage of a human tissue (e.g. a finger of a human) arranged between the gripping structures 4, 4′ can be avoided.

The control unit is configured to increase the force exerted by at least one of the gripping structures 4, 4′ to the object 8 when the detection unit has detected that the at least one of the two or more gripping structures 4, 4′ is in contact with the object 8. Hereby, it is possible to increase the normal force and thus the friction force and thus provide a firm grip of the object 8. In an embodiment, the predefined maximum displacement may be 0.1-0.3 mm, such as 0.2 mm. In another embodiment, the predefined maximum displacement may be 0.4-0.6 mm such as 0.5 mm. In a further embodiment, the predefined maximum displacement may be 0.7-1.0 mm such as 0.8 mm.

FIG. 8B illustrates a top view of a gripping device 2 according to the invention comprising three gripping structures 4, 4′, 4″ each connected to a connection member 6, 6′, 6″ comprising a plurality of telescopic structures arranged to be translated with respect to each other. The gripping device 2 comprises a control unit (not shown) that is operated in a non-contact mode (in which there is no physical contact between the gripping structures 4, 4′, 4″ and the (inside surface of the) pipe-shaped object 8.

FIG. 8C illustrates the gripping device 2 shown in FIG. 8B in a configuration, in which a detection unit (not shown) of the gripping device 2 has detected contact between the object 8 and some of the gripping structures 4′, 4″. There is no contact between the last gripping structure 4 and the object 8. Accordingly, the control unit will regulate the one or more actuators (not shown) arranged to move the gripping structures 4, 4′, 4″ in such a manner that the displacement of the gripping structures 4′, 4″ being in contact with the object 8 is restricted (and thus kept below a predefined maximum allowable level).

In one embodiment, the control unit is configured to allow the gripping structure 4 to be moved towards the object 8 as long as no contact is detected between the gripping structure 4 and the object.

### LIST OF REFERENCE NUMERALS

2 Gripping device
4, 4′ Gripping structure
6, 6′ Connection member
8 Object
10, 10′ Extremity
12, 12 Suction member (e.g. suction disc)
14 Support portion
16 Body portion
18, 18′, 18″ Sensor member (e.g. a pressure sensor)
20 Robot
21 Socket
22 Cable
23 Plug
24 Base
26, 26′, 26″ Arm
28 Attachment structure
30 Attachment member
32 Actuator (e.g. electrical motor)
34 Threaded rod (worm shaft)
38 Connection structure
40 Housing
42 Control unit
58 Object
60 Object
F, F₁, F₂ Force
P, P′ Pressure
D, D₁, D₂ Distance
ΔD Displacement
ΔDₘₐₓ Maximum displacement
F, F₁, F₂ Force exerted by the gripping device
I First phase
II Second phase

1. A method for controlling a gripping device for a robot comprising two or more gripping structures movably arranged relative to each other and configured to grip an object, the method comprising:
actively restricting a displacement (ΔD) of at least one of the two or more gripping structures so that said displacement (ΔD) is less than or equal to a predefined maximum displacement (ΔDₘₐₓ);
detecting when at least one of the two or more gripping structures is in contact with the object; and
increasing a force (F) exerted by at least one of the two or more gripping structures to the object from a predefined first level (F₁) to a predefined second level (F₂) when it has been detected that at least one of the two or more gripping structures is in contact with the object.

2. The method according to claim 1, wherein a ratio between the predefined second level (F₂) and the predefined first level (F₁) is at least 2.0.

3. The method according to claim 1, wherein the step of increasing the force (F) from the predefined first level (F₁) to the predefined second level (F₂) occurs linearly as a function of the displacement of at least one of the two or more gripping structures.

4. The method according to claim 1 further comprising the steps of:
a) detecting when at least one of the two or more gripping structures has been in contact with the object for a predefined time period; and
b) only increasing the force (F) exerted by at least one of the two or more gripping structures to the object if at least one of the two or more gripping structures has been in contact with the object for a time period longer than or equal to the predefined time period.

5. The method according to claim 4, wherein the predefined time period is at least 1 ms.

6. The method according to claim 1, wherein the detection of when at least one of the two or more gripping structures is in contact with the object is carried out by measuring a pressure (P) with which at least one of the two or more gripping structures presses against the object, wherein said pressure (P) is measured by a detection unit comprising one or more sensor members, wherein contact between the object and at least one of the two or more gripping structures is defined as occurring when the pressure (P) exceeds a predefined pressure level (P′).

7. The method according to claim 1 further comprising a step of initially letting the two or more gripping structures move without restricting their relative displacement with respect to each other as long as none of the gripping structures are in contact with the object.

8. The method according to claim 1 further comprising a step of controlling the magnitude of a pressure with which at least one of the two or more gripping structures presses against the object.

9. The method according to claim 1, further comprising a step of detecting at least one parameter indicative of a pressure or force with which at least one of the two or more gripping structures presses against the object.

10. The method according to claim 1 further comprising a step of measuring a current and/or a voltage and/or a force of an actuator arranged to drive at least one of the two or more gripping structures, wherein the contact with an object is defined on the basis of the measured current and/or voltage and/or force.

11. The method according to claim 1 further comprising a step of providing one or more sensors to detect the contact with the object.

12. A gripping device for a robot, said gripping device comprising:
two or more gripping structures movably arranged relative to each other and configured to grip an object;
a detection unit configured to detect when the object is in contact with at least one of the two or more gripping structures,
one or more actuators configured to make at least one of the two or more gripping structures move to grip the object,
a control unit configured to control the one or more actuators,
wherein the control unit is configured to restrict displacement (ΔD) of at least one of the two or more gripping structures so that said displacement (ΔD) is less than or equal to a predefined maximum displacement (ΔDₘₐₓ), and wherein the gripping device is configured to increase a force (F) exerted by at least one of the two or more gripping structures to the object from a predefined first level (F₁) to a predefined second level (F₂) when the detection unit has detected that at least one of the two or more gripping structures is in contact with the object.

13. The gripping device according to claim 12, wherein a ratio between the predefined second level (F₂) and the predefined first level (F₁) is at least 2.0.

14. The gripping device according to claim 12, wherein the gripping device is configured to increase the force (F) from the predefined first level (F₁) to the predefined second level (F₂) linearly as a function of the displacement of at least one of the two or more gripping structures.

15. The gripping device according to claim 12, wherein the detection unit is configured to detect when at least one of the two or more gripping structures has been in contact with the object for a predefined time period, wherein the control unit is configured to only increasing the force (F) exerted by at least one of the two or more gripping structures to the object if at least one of the two or more gripping structures has been in contact with the object for a time period longer than or equal to the predefined time period.

16. The gripping device according to claim 12, wherein the gripping device is configured to initially let the two or more gripping structures move without restricting their relative displacement with respect to each other as long as none of the gripping structures are in contact with the object.

17. The gripping device according to claim 12, wherein the gripping device is configured to control a magnitude of a pressure with which at least one of the two or more gripping structures presses against the object.

18. The gripping device according to claim 12, wherein the gripping device is configured to measure a current and/or a voltage and/or a force of an actuator arranged to drive at least one of the two or more gripping structures, wherein the contact with the object is defined on the basis of the measured current and/or voltage and/or force.

19. The gripping device according to claim 18, wherein the detection unit is an integrated detection unit configured to detect when the object is in contact with at least one of the two or more gripping structures on the basis of measurements performed on one or more of the actuators and the control unit is configured to restrict the displacement (ΔD) of at least one of the two or more gripping structures when the integrated detection unit has detected that the object is in contact with at least one of the two or more gripping structures.

20. The gripping device according to claim 12, wherein the detection unit comprises one or more sensor members.
